(19) United States
(12) Patent Application Publication
(10) Pub. No.: US 2020/0272835 A1
(43) Pub. Date: Aug. 27, 2020

(54) INTELLIGENT DRIVING CONTROL METHOD, ELECTRONIC DEVICE, AND MEDIUM

(71) Applicant: BEIJING SENSETIME TECHNOLOGY DEVELOPMENT CO., LTD., Beijing (CN)

(72) Inventors: Guangliang CHENG, Beijing (CN); Jianping SHI, Beijing (CN)

(21) Appl. No.: 16/870,280

(22) Filed: May 8, 2020

Related U.S. Application Data
(63) Continuation of application No. PCT/CN2019/092134, filed on Jun. 20, 2019.

(30) Foreign Application Priority Data
Aug. 22, 2018 (CN) 201810961511.8

(51) Int. Cl. G06K 9/00; B60W 30/12; B60W 50/14

(52) U.S. Cl. CPC G06K 9/00798; B60W 50/14; B60W 30/12

(57) ABSTRACT

An intelligent driving control method, an electronic device, and a medium are provided. The method comprises: obtaining a lane line detection result of a running environment of a vehicle; determining, according to a running state of the vehicle and the lane line detection result, an estimated distance at which the vehicle drives out of a lane line; in response to the estimated distance being greater than a first preset distance value and less than or equal to a second preset distance value, determining an estimated time after which the vehicle drives out of the lane line; and performing intelligent driving control according to the estimated time.

### CROSS-REFERENCE TO RELATED APPLICATIONS

The present application is a continuation of International Patent Application No. PCT/CN2019/092134, filed on Jun. 20, 2019, which claims priority to Chinese Patent Application No. 201810961511.8, filed on Aug. 22, 2018. The disclosures of International Patent Application No. PCT/CN2019/092134 and Chinese Patent Application No. 201810961511.8 are hereby incorporated by reference in their entireties.

### BACKGROUND

With the development of automatic driving, in order to improve the safety of automatic driving during running on a road, a lane line on the road needs to be detected. Lane line detection is mainly used for a visual navigation system to find, from a captured road image, the position of a lane line in a road detection image. However, after a lane line is detected, how to use the detected lane line to perform lane line departure early-warning in time becomes an important element considered by intelligent driving products such as automatic driving products and assisted driving products.

### SUMMARY

Embodiments of the present disclosure relate to the technical field of intelligent driving, and in particular, to an intelligent driving control method, an electronic device, and a medium.

Embodiments of the present disclosure provide an intelligent driving control method and apparatus, an electronic device, a program, and a medium.

In a first aspect, the embodiments of the present disclosure provide an intelligent driving control method, including: obtaining a detection result of a lane line in a running environment of a vehicle; determining, according to a running state of the vehicle and the detection result of the lane line, an estimated distance by which the vehicle drives out of a lane line; in response to the estimated distance being greater than a first preset distance value and less than or equal to a second preset distance value, determining an estimated time for which the vehicle drives out of the lane line; and performing intelligent driving control according to the estimated time.

In a second aspect, the embodiments of the present disclosure provide an electronic device, including: a memory configured to store a computer program; and a processor configured to execute the computer program stored to implement the method according to the first aspect.

In a third aspect, the embodiments of the present disclosure provide a computer storage medium which stores a computer program, where the computer program, when being executed, causes to implement the method according to the first aspect.

The intelligent driving control method and apparatus, electronic device, program, and medium provided by the embodiments of the present disclosure obtain a lane line detection result of a running environment of a vehicle; determine, according to a running state of the vehicle and the lane line detection result, an estimated distance at which the vehicle drives out of a lane line; according to the estimated distance and/or an estimated time, in response to the estimated distance being greater than a first preset distance value and less than or equal to a second preset distance value, determine an estimated time after which the vehicle drives out of the lane line; and perform intelligent driving control according to the estimated time. Therefore, the embodiments of the present disclosure implement the intelligent control on a running state of a vehicle based on a lane line to reduce or avoid the occurrence of traffic accidents due to that a vehicle drives out of a lane line, thereby improving driving safety.

### BRIEF DESCRIPTION OF DRAWINGS

FIG. 1 is a flowchart of an intelligent driving control method provided by embodiment I of the present disclosure.

FIG. 2 is a schematic structural diagram of a neural network model involved in the embodiment I.

FIG. 3 is a schematic diagram of relative positions of a vehicle and a lane line involved in the embodiment I.

FIG. 4 is a flowchart of an intelligent driving control method provided by embodiment II of the present disclosure.

FIG. 5 is a flowchart of an intelligent driving control method provided by embodiment III of the present disclosure.

FIG. 6 is a schematic diagram of relative positions of a vehicle and a lane line involved in the embodiment II.

FIG. 7 is another schematic diagram of the relative positions of the vehicle and the lane line involved in the embodiment II.

FIG. 8 is a schematic structural diagram of an intelligent driving control apparatus provided by embodiment I of the present disclosure.

FIG. 9 is a schematic structural diagram of an intelligent driving control apparatus provided by embodiment II of the present disclosure.

FIG. 10 is a schematic structural diagram of an intelligent driving control apparatus provided by embodiment III of the present disclosure.

FIG. 11 is a schematic structural diagram of an intelligent driving control apparatus provided by embodiment IV of the present disclosure.

FIG. 12 is a schematic structural diagram of an intelligent driving control apparatus provided by embodiment V of the present disclosure.

FIG. 13 is a schematic structural diagram of an intelligent driving control apparatus provided by embodiment VI of the present disclosure.

FIG. 14 is a schematic structural diagram of an application embodiment of an electronic device of the present disclosure.

### DETAILED DESCRIPTION

In order to make the purpose, the technical solutions and the advantages of the embodiments of the present disclosure more clearly, the technical solutions in the embodiments of the present invention are clearly and fully described below with reference to the accompanying drawings in the embodiments of the present disclosure. Apparently, the described embodiments are merely some of the embodiments of the present disclosure, but not all the embodiments. Based on the embodiments of the present disclosure, all other embodiments obtained by a person of ordinary skill in the art without involving an inventive effort shall fall within the scope of protection of the present disclosure.

The embodiments of the present disclosure may be applied to electronic devices such as terminal devices, computer systems, and servers, which may operate with numerous other general-purpose or special-purpose computing system environments or configurations. Examples of well-known terminal devices, computing systems, environments, and/or configurations suitable for use together with the electronic devices such as terminal devices, computer systems, and servers include, but are not limited to, personal computer systems, server computer systems, thin clients, thick clients, handheld or laptop devices, systems based on microprocessors, Central Processing Units (CPUs), Graphics Processing Units (GPUs), and Field-Programmable Gate Arrays (FPGAs), set top boxes, programmable consumer electronics, network personal computers, small computer systems, large computer systems, distributed cloud computing environments and vehicle-mounted devices that include any one of the foregoing systems, and the like.

The electronic devices such as terminal devices, computer systems, and servers may be described in the general context of computer system executable instructions (for example, program modules) executed by the computer system. Generally, the program modules may include routines, programs, target programs, components, logics, data structures, and the like for performing specific tasks or implementing specific abstract data types. The computer systems/servers may be practiced in the distributed cloud computing environments in which tasks are executed by remote processing devices that are linked through a communications network. In the distributed computing environments, the program modules may be located in local or remote computing system storage media including storage devices.

The technical solutions of the present disclosure are described below with the specific embodiments. The specific embodiments below can be combined with each other. For the same or similar concepts or processes may not be described in detail in some embodiments.

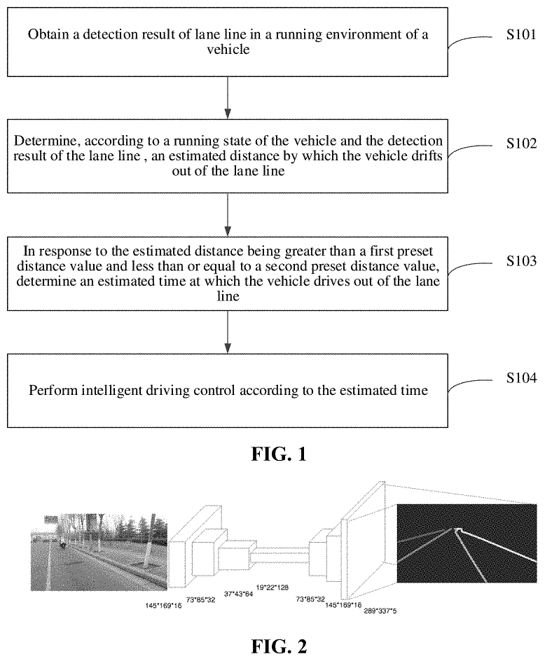

FIG. 1 is a flowchart of an intelligent driving control method provided by embodiment I of the present disclosure. As shown in FIG. 1, the method of this embodiment includes: at S101, a detection result of a lane line in a running environment of a vehicle is obtained.

This embodiment is described with an electronic device as an execution body. The electronic device may be, but not limited to, a smart phone, a computer, a vehicle-mounted system, and the like.

According to one or more embodiments of the present disclosure, the electronic device of this embodiment may further have a camera capable of photographing a running environment of a vehicle, for example, the front (or the surroundings) of a road on which the vehicle runs, to generate a road detection image, and sending the road detection image to a processor of the electronic device.

According to one or more embodiments of the present disclosure, the electronic device of this embodiment may be connected to an external camera. The camera is capable of photographing a running environment of a vehicle to generate a road detection image, and the electronic device can obtain the road detection image from the camera.

This embodiment does not limit the specific mode in which the electronic device obtains the road detection image.

The road detection image of this embodiment includes at least one lane line.

This embodiment does not limit the method for obtaining the detection result of the lane line in the running environment of the vehicle. For example, the lane line detection result of the running environment of the vehicle may be obtained in the following mode: detecting a lane line in the running environment of the vehicle based on a neural network, for example, performing, by means of a neural network, lane line detection on an image including the running environment of the vehicle to obtain the lane line detection result; or obtaining the lane line detection result of the running environment of the vehicle directly from an Advanced Driver Assistance Systems (ADAS) or an unmanned driving system, and directly using the lane line detection result from the ADAS or unmanned driving system. Reference can be made to FIG. 2 for the detecting a lane line in the running environment of the vehicle based on a neural network. Specifically, the road detection image on the leftmost side in FIG. 2 is input into a preset trained neural network model to obtain the probability map of each lane line (as shown on the rightmost side in FIG. 2). Then, curve fitting is performed on points corresponding to the lane line in the probability map to generate a fitted curve of the lane line.

According to one or more embodiments of the present disclosure, the preset neural network model may be a Fully Convolutional Network (FCN) model, a Residual Network (Res Net) model, a convolutional neural network model, and the like.

According to one or more embodiments of the present disclosure, as shown in FIG. 2, the neural network model of this embodiment may include seven convolutional layers, which are respectively a first convolutional layer having a parameter of 145*169*16, a second convolutional layer having a parameter of 73*85*32, a third convolutional layer having a parameter of 37*43*64, a fourth convolutional layer having a parameter of 19*22*128, a fifth convolutional layer having a parameter of 73*85*32, a sixth convolutional layer having a parameter of 145*169*16, and seventh convolutional layer having a parameter of 289*337*5.

In this embodiment, each lane line corresponds to a probability map. For example, if the road detection image shown on the leftmost side of FIG. 2 includes four lane lines, the neural network model can output four probability maps.

According to one or more embodiments of the present disclosure, in order to facilitate the comparison with the road detection image, the probability maps of all the lane lines may be combined to form one probability map. For example, the probability maps of the four lane lines are combined to generate the probability map shown on the rightmost side in FIG. 2.

The probability map of each lane line includes a plurality of probability points, and the probability points have one-to-one correspondence with pixel points in the road detection image. The values of the probability points are probability values the pixel points at corresponding positions in the road detection image are on the lane line.

The values of the probability points in FIG. 2 represent probability values the pixel points at corresponding positions in the road detection image are on the lane line. As shown in FIG. 2, the probability value of the white probability points is 1, and the probability value of the black probability points is 0. Based on the probability map shown in FIG. 2, the probability points in FIG. 2 having probability values greater than a preset value are obtained, the pixel points corresponding to these probability points being points on the lane line, and curve fitting is performed on the points to generate a fitted curve of the lane line. The preset value is a criterion for determining whether the pixel points corresponding to the probability points are on the lane line, and the preset value can be determined according to actual requirements. For example, if the preset value is 0.8, the points in FIG. 2 having a probability value greater than 0.8, i.e., the white probability points in FIG. 2, can be selected, and curve fitting is performed on the pixel points corresponding to these white probability points such that a fitted curve of the lane line can be obtained.

According to one or more embodiments of the present disclosure, during the curve fitting in this embodiment, linear function curve fitting, quadratic function curve fitting, cubic function curve fitting, or high-degree function curve fitting may be used. This embodiment does not limit the fitting mode of the fitted curve, and the fitting mode is specifically determined according to actual requirements.

At S102, an estimated distance by which the vehicle drives out of a lane line is determined according to a running state of the vehicle and the lane line detection result.

Based on the intelligent driving control method provided by the foregoing embodiment of the present disclosure, the lane line detection result of the running environment of the vehicle is obtained, and the estimated distance at which the vehicle drives out of the lane line is determined according to the running state of the vehicle and the lane line detection result.

For example, the running state of the vehicle includes a running direction of the vehicle and the current coordinate position of the vehicle, and the lane line detection result includes the fitted curve of the lane line. Based on the foregoing information, the estimated distance at which the vehicle drives out of the lane line can be determined.

At S103, in response to the estimated distance being greater than a first preset distance value and less than or equal to a second preset distance value, an estimated time after which the vehicle drives out of the lane line is determined.

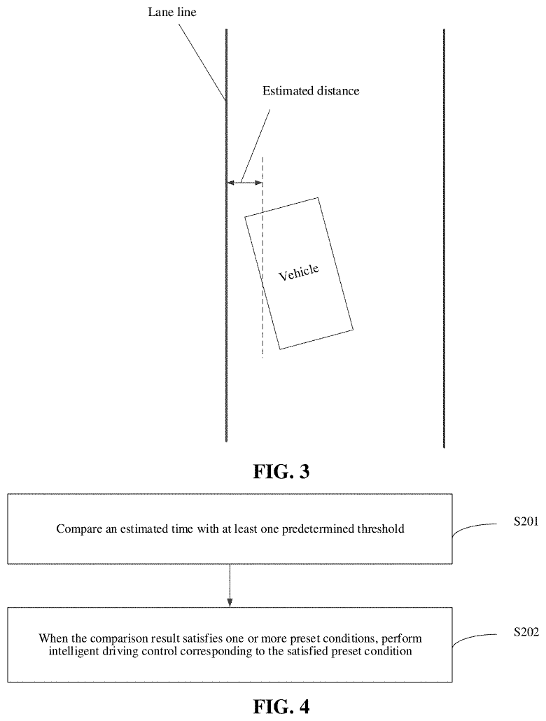

For example, as shown in FIG. 3, in this embodiment, the estimated distance d at which the vehicle drives out of the lane line is obtained, and the estimated distance d is compared with the first preset distance value a. If the estimated distance d is greater than the first preset distance value a and less than or equal to the second preset value b, i.e., a<d<b, the estimated time after which the vehicle drives out of the vehicle needs to be determined. Furthermore, intelligent driving control is performed according to the estimated time.

In one example, the running state of the vehicle includes the running speed of the vehicle, and the estimated time after which the vehicle drives out of the lane line can be determined according to the estimated distance at which the vehicle drives out of the lane line and the running speed of the vehicle.

In another example, the electronic device of this embodiment is connected to a bus of the vehicle, and can read the running speed v of the vehicle from the bus. Thus, according to the running speed v of the vehicle and the estimated distance d, the estimated time t after which the vehicle drives out of the lane line at the current running speed v is determined, for example, t=d/v.

At S104, intelligent driving control is performed according to the estimated time.

According to one or more embodiments of the present disclosure, the intelligent driving control performed on the vehicle according to the estimated time, for example, may include but not limited to at least one of the following types of control on the vehicle: automatic driving control, assisted driving control, driving mode switching control (for example, switching from an automatic driving mode to a non-automatic driving mode or switching from the non-automatic driving mode to the automatic driving mode), and the like. The driving mode switching control can control the vehicle to switch from the automatic driving mode to the non-automatic driving mode (the non-automatic driving mode is, for example, a manual driving mode) or switching from the non-automatic driving mode to the automatic driving mode. The automatic driving control on the vehicle, for example, may include but not limited to any one or more of the following types of control on the vehicle: operations for controlling the running state of the vehicle, such as performing lane line departure warning, performing braking, performing deceleration, changing a running speed, changing a running direction, performing lane line keeping, and changing a vehicle lamp state. The assisted driving control on the vehicle, for example, may include but not limited to any one or more of the following types of control on the vehicle: operations which help prompting a driver to control the running state of the vehicle, such as performing lane line departure early-warning and performing lane line keeping prompting.

The intelligent driving control method provided by the embodiments of the present disclosure obtains a lane line detection result of a running environment of a vehicle; determines, according to a running state of the vehicle and the lane line detection result, an estimated distance at which the vehicle drives out of a lane line; according to the estimated distance and/or an estimated time, in response to the estimated distance being greater than a first preset distance value and less than or equal to a second preset distance value, determines an estimated time after which the vehicle drives out of the lane line; and performs intelligent driving control according to the estimated time. Therefore, the embodiments of the present disclosure implement the intelligent control on a running state of a vehicle based on a lane line to reduce or avoid the occurrence of traffic accidents due to that a vehicle drives out of a lane line, thereby improving driving safety.

According to one or more embodiments of the present disclosure, the method further includes: in response to the estimated distance being less than or equal to the second preset distance value or less than the first preset distance value, automatically activating an intelligent driving control function; or in response to the estimated time being less than a predetermined threshold, automatically activating the intelligent driving control function; or in response to detecting that the vehicle drives onto the lane line, automatically activating the intelligent driving control function.

For example, during a normal driving process, the automatic driving control function is in a disabled or sleep state. If the estimated distance is less than or equal to the second preset distance value or less than the first preset distance value, or if the estimated time is less than the predetermined threshold, or if it is detected that the vehicle drives onto the lane line, the intelligent driving control function is automatically activated, such that the energy consumption of a module corresponding to the automatic driving control function can be reduced, thereby prolonging the working period of the module corresponding to the automatic driving control function.

FIG. 4 is a flowchart of an intelligent driving control method provided by embodiment II of the present disclosure. Based on the foregoing embodiment, this embodiment relates to the specific process for performing intelligent driving control according to the estimated time. As shown in FIG. 4, the foregoing S104 includes: S201, comparing the estimated time with at least one predetermined threshold; and S202, when the comparison result satisfies one or more preset conditions, performing intelligent driving control corresponding to the satisfied preset condition.

The at least one predetermined threshold is determined according to actual requirements, and this is not limited in this embodiment.

For example, according to one or more embodiments of the present disclosure, the when the comparison result satisfies one or more preset conditions, performing intelligent driving control corresponding to the satisfied preset condition includes: if the estimated time is less than or equal to a first preset time value and greater than a second preset time value, performing lane line departure early-warning on the vehicle. For example, a prompt that the vehicle departs the current lane or is to drift out of the current lane line, and the like, is provided.

The performing lane line departure early-warning includes at least one of flickering a light, ringing, or providing a voice prompt.

The second preset time value is less than the first preset time value. For example, the values of a first preset threshold and a second preset threshold are respectively 5 s and 3 s.

In this embodiment, if the estimated time is less than or equal to the first preset time value and greater than the second preset time value, lane line departure warning is performed on the vehicle, such that the driver can be prompted to know that the vehicle departs the lane line to promptly take a corresponding driving measure to avoid the vehicle from drifting out of the lane line, thereby improving the driving safety. By performing lane line departure prompting according to the vehicle, the estimated distance to the lane line, and the estimated time after which the vehicle is predicted to drift out of the lane line, the accuracy of lane line departure early-warning is improved.

According to one or more embodiments of the present disclosure, the followings are further included: if the estimated time is less than or equal to the second preset time value, performing automatic driving control and/or lane line departure warning on the vehicle; or if a first distance is less than or equal to the first preset distance value, performing automatic driving control and/or lane line departure warning on the vehicle, where the lane line departure early-warning includes the lane line departure warning. The performing lane line departure warning includes: performing warning in an acoustic mode, an optical mode, an electrical mode, and the like, for example, turning on a turn signal light and/or providing a voice prompt.

In the foregoing embodiment, as the estimated distance and/or estimated time decreases gradually, the respective corresponding degrees of intelligent driving control increase incrementally, from the performing lane line departure prompting on the vehicle to the performing automatic driving control and/or lane line departure warning on the vehicle, to avoid the vehicle from drifting out of the lane line, thereby improving the driving safety.

According to one or more embodiments of the present disclosure, the if the estimated time is less than or equal to the second preset time value, performing automatic driving control and/or lane line departure warning on the vehicle includes: if estimated times determined based on an image and a historical image frame are all less than or equal to the second preset time value, performing automatic driving control and/or lane line departure warning on the vehicle. Alternatively, the if a first distance is less than or equal to the first preset distance value, performing automatic driving control and/or lane line departure warning on the vehicle includes: if estimated distances determined based on the image and the historical image frame are all less than or equal to the first preset distance value, performing automatic driving control and/or lane line departure warning on the vehicle, where the historical image frame includes at least one image frame, in a video where the image is located, having a detection time sequence prior to that of the image.

In this embodiment, statistics about the estimated distance and the estimated time of the historical image frame are collected simultaneously as bases for performing automatic driving control and/or lane line departure warning on the vehicle, such that the accuracy of performing automatic driving control and/or lane line departure warning on the vehicle can be improved.

According to one or more embodiments of the present disclosure, in one possible implementation of this embodiment, the method further includes: obtaining a driving level of a driver of the vehicle; and adjusting, according to the driving level, at least one of the first preset distance value, the second preset distance value, the first preset time value, or the second preset time value.

According to one or more embodiments of the present disclosure, the driving level of the driver of the vehicle is obtained, where the driving level is used for indicating the vehicle driving proficiency of the driver. Then, at least one of the first preset distance value, the second preset distance value, the first preset time value or the second preset time value is adjusted according to the driving level. For example, a high driving level of the driver indicates high vehicle driving proficiency of the driver, such that the at least one of the first preset distance value, the second preset distance value, the first preset time value or the second preset time value corresponding to the drive can be adjusted down. A low driving level of the driver indicates low vehicle driving proficiency of the driver, such that at least one of the first preset distance value, the second preset distance value, the first preset time value or the second preset time value corresponding to the drive can be adjusted up to ensure safe driving of the vehicle.

The driving level of the driver may be manually entered by the driver and may also be determined according to the driving term on the driver's license obtained by scanning the driver's license of the driver. For example, the longer the driving term of the driver, the higher the corresponding driving level. In other embodiments, the driving level of the driver may also be obtained by other methods.

The embodiments of the present disclosure can be applied to automatic driving and assisted driving scenes to implement precise lane line detection, automatic driving control and vehicle lane line departure early-warning.

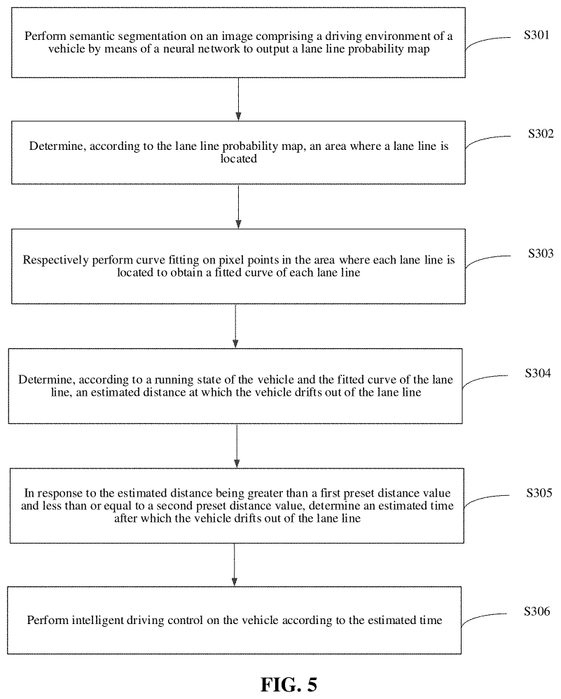

FIG. 5 is a flowchart of an intelligent driving control method provided by embodiment III of the present disclosure. As shown in FIG. 5, the intelligent driving control method of this embodiment includes: at S301, semantic segmentation is performed on an image comprising the running environment of the vehicle by means of a neural network to output a lane line probability map. The lane line probability map is used for representing a probability value that at least one pixel point in the image separately belongs to a lane line.

The neural network in the embodiment of the present disclosure may be a deep neural network, for example, a convolutional neural network which may be obtained by training a neural network by a sample image and a pre-annotated accurate lane line probability map in advance. The training a neural network by a sample image and an accurate lane line probability map may be, for example, implemented in the following mode: performing semantic segmentation on a sample image by means of a neural network to output a lane line probability map; obtaining a loss function value of the neural network according to a difference in at least one corresponding pixel point between a predicted lane line probability map and an accurate lane line probability map; and training the neural network on the basis of the loss function value, for example, adjusting parameter values of network layer parameters in the neural network on the basis of a gradient update training method by a chain rule-based backpropagation gradient until a preset condition, for example, the difference in at least one corresponding pixel point between a predicted lane line probability map and an accurate lane line probability map being less than a preset difference value and/or the number of training times for the neural network reaching a preset number of times, is satisfied, so as to obtain a trained neural network.

According to one or more embodiments of the present disclosure, before the step S301, another embodiment of the intelligent driving control method of the present disclosure further includes: pre-processing an original image of the running environment of the vehicle to obtain the image comprising the running environment of the vehicle. Correspondingly, at step S301, semantic segmentation is performed on the pre-processed image by means of the neural network.

The pre-processing the original image by means of the neural network may be, for example, performing zooming, cropping, etc., on the original image acquired by a camera to zoom and crop the original image into an image of a preset size and inputting same to the neural network for processing, so as to reduce the complexity of the semantic segmentation performed on the image by means of the neural network, reducing time consumption, and improving to the processing efficiency.

In addition, the pre-processing the original image by means of the neural network may further be, for example, selecting on the basis of a preset image quality (for example, the definition, exposure, and the like, of the image) standard some images of good quality from the original images acquired by the camera and inputting same to the neural network for processing, thereby improving the accuracy of semantic segmentation, so as to improve the accuracy of lane line detection.

According to one or more embodiments of the present disclosure, at step S301, the performing semantic segmentation on an image comprising the running environment of the vehicle by means of a neural network to output a lane line probability map includes: performing feature extraction on the image by means of the neural network to obtain feature maps; and performing semantic segmentation on the feature maps by means of the neural network to obtain lane line probability maps of N lane lines. The pixel values of the pixel points in the lane line probability map of each lane are used for representing the probability values the corresponding pixel points in the image respectively belong to the lane line, where the value of N is an integer greater than 0. For example, the value of N is 4.

The neural network in the embodiments of the present disclosure includes: a network layer for feature extraction and a network layer for classification. The network layer for feature extraction may include, for example, a convolution layer, a Batch Normalization (BN) layer, and a non-linear layer. The convolution layer, the BN layer, and the non-linear layer sequentially perform feature extraction on the image to generate feature maps, and the network layer for classification performs semantic segmentation on the feature maps to obtain the lane line probability maps of a plurality of lane lines. The lane line probability maps of N lane lines may be one probability map of a channel. The pixel values of the pixel points in the probability map respectively represent the probability values the corresponding pixel points in the image belong to the lane line. In addition, the lane line probability maps of N lane lines may also be probability maps of N+1 channels. The N+1 channels respectively correspond to N lane lines and a background. That is, the probability map of each channel in the probability map of N+1 channels respectively represents the probability that at least one pixel point in the image separately belongs to the lane line corresponding to the channel or the background.

According to one or more embodiments of the present disclosure, the performing semantic segmentation on the feature maps by means of the neural network to obtain lane line probability maps of N lane lines includes: performing semantic segmentation on the feature maps by means of the neural network to obtain probability maps of N+1 channels. The N+1 channels respectively correspond to N lane lines and a background. That is, the probability map of each channel in the probability maps of N+1 channels respectively represents the probability that at least one pixel point in the image separately belongs to the lane line corresponding to the channel or the background. The lane line probability maps of N lane lines are obtained from the probability maps of the N+1 channels.

The neural network in the embodiments of the present disclosure includes: a network layer for feature extraction, a network layer for classification, and a normalization (Softmax) layer. Each network layer for feature extraction performs sequentially feature extraction on the image to generate a series of feature maps. The network layer for classification performs semantic segmentation on the finally output feature maps to obtain the lane line probability maps of N+1 channels, and the Softmax layer is used for performing normalization processing on the lane line probability maps of N+1 channels to convert the probability values of the pixel points in the lane line probability maps into numeral values ranging from 0 to 1.

In the embodiments of the present disclosure, the network layer for classification preforms multi-class classification on the pixel points in the feature maps. For example, for a scene with four lane lines (referred to as a left-left lane line, a left lane line, a right lane line, and a right-right lane line), five-class classification is performed on the pixel points in the feature maps to recognize the probability values the pixel points in the image respectively belong to five classes (the background, the left-left lane line, the left lane line, the right lane line, and the right-right lane line), and probability maps where the pixel points in the feature maps belong to one of the classes are output respectively to obtain the probability maps of N+1 channels. The probability values of the pixels in each probability map represent the probability values the pixels in the image corresponding to said pixels in each probability map belong to a given class.

In the foregoing embodiments, N is the number of lane lines in the running environment of the vehicle, and is any integer greater than 0. For example, if the value of N is 2, the N+1 channels respectively correspond to the background, the left lane line and the right lane line in the running environment of the vehicle; or if the value of N is 3, the N+1 channels respectively correspond to the background, the left lane line, the middle lane line, and the right lane line in the running environment of the vehicle; or if the value of N is 4, the N+1 channels respectively correspond to the background, the left-left lane line, the left lane line, the right lane line, and the right-right lane line in the running environment of the vehicle.

At S302, an area where the lane line is located is determined according to the lane line probability map. The lane line detection result includes the area where the lane line is located.

On the basis of the intelligent driving control method provided by this embodiment, semantic segmentation is performed on the image by means of the neural network to output the lane line probability map, and the area where the lane line is located is determined according to the lane line probability map. Because the neural network can automatically learn about different features of the lane line on the basis of a deep learning mode by learning about a large number of annotated lane line images, for example, lane line images in scenes, such as a curve path, a lane line loss, a curb edge, dim light, and backlight, without manually designing features by persons, the process is simplified and the manual annotation costs are reduced. In addition, the neural network can effectively recognize lane lines in different driving scenes to implement lane line detection in different complex scenes, such as a curve path, a lane line loss, a curb edge, dim light, and backlight, so as to improve the accuracy of lane line detection to obtain an accurate estimated distance and/or estimated time, thereby providing the accuracy of intelligent driving control and improving driving safety.

According to one or more embodiments of the present disclosure, at step S302, the determining, according to a lane line probability map of a lane line, an area where the lane line is located includes: selecting, from the lane line probability map, a pixel point having a probability value greater than a first preset threshold; performing, on the basis of the selected pixel point, maximum connected area searching in the lane line probability map to find out a pixel point set belonging to the lane line; and determining, on the basis of the pixel point set belonging to the lane line, the area where the lane line is located.

For example, a breath-first search algorithm can be used for performing the maximum connected area searching to find out all connected areas having probability values greater than the first preset threshold, and then all the connected area are compared to find out the maximum area as the detected area where the lane line is detected.

The output of the neural network is the lane line probability maps of a plurality of lane lines. The pixel value of each pixel point in the lane line probability map represents the probability value a pixel point in the corresponding image belongs to a given lane line. The value is a numerical value ranging from 0 to 1 after normalization. A pixel point, in the lane line probability map, that very probably belongs to the lane line to which the lane line probability map belongs is selected according to the first preset threshold, and then maximum connected area searching is executed to find out the pixel point set belonging to the lane line as the area where the lane line is located. The foregoing operations are respectively performed on each lane line, such that the areas where the lane lines are located can be determined.

According to one or more embodiments of the present disclosure, the determining, on the basis of the pixel point set belonging to the lane line, the area where the lane line is located includes: counting the sum of the probability values of all pixel points in the pixel point set belonging to the lane line to obtain the confidence of the lane line; and if the confidence is greater than a second preset threshold, taking the area formed by the pixel point set as the area where the lane line is located.

In the embodiments of the present disclosure, for each lane line, the sum of the probability values of all pixel points in the pixel point set is counted to obtain the confidence of the lane line. The confidence is the probability value the area formed by the pixel point set is a real lane line. The second preset threshold is an experience value which is set according to actual requirements and can be adjusted according to actual scenes. If the confidence is too small, i.e., not greater than the second preset threshold, it indicates that the lane line does not exist, and the determined lane line is discarded. If the confidence is large, i.e., greater than the second preset threshold, it indicates that the probability value the area where the determined lane line is located is a real lane line is high, and the area is determined as the area where lane line is located.

At S303, curve fitting is respectively performed on pixel points in the area where each lane line is located to obtain a fitted curve of each lane line.

There is a plurality of representations for lane line information. For example, the lane line information may be a curve, a straight line, a scatter plot chart including at least one point on the lane line and the distance from the at least one point to the vehicle, a data table, an equation, or the like. The embodiments of the present disclosure do not limit the specific representations of the lane line information. If the lane line information is represented as an equation, the equation is referred to as a lane line equation. In some optional examples, the lane line equation is a quadratic curve equation and is represented as: x=a*y*y+b*y+c. The lane line equation has three parameters (a, b, c).

According to one or more embodiments of the present disclosure, at step S303, the performing curve fitting on pixel points in the area where one lane line is located to obtain lane line information of the lane line includes: selecting a plurality of (for example, three or more) pixel points from the area where one lane line is located; and converting the plurality of selected pixel points from a camera coordinate system where the camera is located into a world coordinate system to obtain the coordinates of the plurality of pixel points in the world coordinate system. The origin of the world coordinate system is set according to requirements. For example, the landing point of the left front wheel of the vehicle may be set as the origin, and the y-axis direction in the world coordinate system is the front direction of the vehicle. Curve fitting is performed in the world coordinate system on the plurality of pixel points according to the coordinates of the plurality of pixel points in the world coordinate system to obtain the lane line information of said one lane line.

For example, some pixel points are randomly selected from the area where said one lane line is located, these pixel points are converted to the world coordinate system according to camera calibration parameters (which may also be referred to as video camera calibration parameters), and then curve fitting is performed in the world coordinate system on these pixel point to obtain a fitted curve. The camera calibration parameters include internal parameters and external parameters. The position and orientation of the camera or video camera in the world coordinate system are determined according to the external parameters. The external parameters include a rotation matrix and a translation matrix. The rotation matrix and the translation matrix jointly describe how to convert the point from the world coordinate system into the camera coordinate system or vice versa. The internal parameters are parameters related to the characteristics of the camera, such as the focal length and the pixel size of the camera.

The curve fitting refers to computing, according to some discrete points, a curve constituted by these points. According to one or more embodiments of the present disclosure, curve fitting may be performed, for example, on the basis of the plurality of pixel points using a least square method.

In addition, in another embodiment of the intelligent driving control method of the present disclosure, in order to prevent lane line jittering determined on the basis of two frames of images and chaos generated to the lane line during the process the vehicle changes a lane, after obtaining the lane line formation of the lane line by means of step S303, the intelligent driving control method further includes: filtering parameters in the lane line information of the lane line to filter jittering and some anomalies, so as to ensure the stability of the lane line information. According to one or more embodiments of the present disclosure, the filtering parameters in the lane line information of one lane line includes: performing, according to the parameter values of the parameters in the lane line information of the lane line and the parameter values of parameters in historical lane line information of the lane line obtained on the basis of a previous image frame, Kalman filtering on the parameter values of the parameters in the lane line information. The previous image frame is an image frame, in the video where the image is located, having a detection time sequence prior to that of the image. For example, the previous image frame mage may be a previous image frame adjacent to the image, or may also be an image having a detection time sequence prior to that of the image and being spaced apart from the image by one or more frames.

Kalman filtering is an estimation method for making, according to statistical characteristics of a time varying random signal, a future value of the signal be close to a truth value as far as possible. In this embodiment, the performing, according to the parameter values of the parameters in the lane line information of the lane line and the parameter values of parameters in historical lane line information of the lane line obtained on the basis of a previous image frame, Kalman filtering on the parameter values of the parameters in the lane line information can improve the accuracy of lane line information and facilitate subsequent accurate determination of information such as the distance between the vehicle and the lane line, thereby performing accurate lane line departure early-warning on the vehicle.

In yet another embodiment of the intelligent driving control method of the present disclosure, before performing Kalman filtering on the parameter values of the parameters in the lane line information, the intelligent driving control method further includes: for the same lane, selecting the lane line information as effective lane line information for Kalman filtering, i.e., performing smoothing on the parameters (for example, the three parameters (a, b, c) in x=a*y*y+b*y+c) in the lane line information, where the parameter values of the parameters in the lane line information have changed with respect to the parameter values of the corresponding parameters in the historical lane line information, and the differences between the parameter values of the parameters in the lane line information and the parameter values of the corresponding parameters in the historical lane line information are all less than a third preset threshold. In the video, the parameters in the lane line information fitted on the basis of each frame would change, but the adjacent frames of images would not change a lot. Therefore, certain smoothing can be performed on the lane line information of the current image frame to filter jittering and some anomalies, thereby ensuring the stability of the lane line information.

For example, for lane lines determined by the first image frame in the video that participates in lane line detection, a tracker is established respectively for each lane line to track the lane line. If the current image frame detects the same lane line, and the differences between the parameter values in the lane line information of the lane line and the parameter values in the lane line information of the same lane line determined by the previous image frame are all less than the third preset threshold, the parameter values in the lane line information of the current image frame are updated to the tracker of the same lane line determined by the previous image frame to perform Kalman filtering on the lane line information of the same lane line in the current image frame. If two consecutive frames of images are updated in the tracker of the same lane line, it indicates that the determination result of the lane line is accurate. The tracker of the lane line can be confirmed and the lane line tracked by the tracker is set as the final lane line result. If multiple consecutive frames are not updated in the tracker, it is considered that the corresponding lane line disappears. The tracker is deleted. If no lane line matching the previous image frame is detected in the current image frame, it indicates that a large error occurs in the lane line determined in the previous image frame. The tracker in the previous image frame is deleted.

At S304, an estimated distance at which the vehicle drives out of the lane line is determined according to the running state of the vehicle and the fitted curve of the lane line.

In the embodiments of the present disclosure, after determining the area where the lane line is located, curve fitting is performed on the pixel points in the area where each lane line is located to obtain the lane line information of each lane line, and the estimated distance at which the vehicle drives out of the corresponding lane line is determined on the basis of the running state of the vehicle and the lane line information of the lane line. Because the lane line information obtained by curve fitting is represented as a quadratic curve or is in a similar representation, the lane line information can well fit a curve path lane line, is still well applicable to a curve path, and is suitable for the early-warning of different road states.

According to one or more embodiments of the present disclosure, at step S304, the determining, according to the running state of the vehicle and the fitted curve of the lane line, an estimated distance at which the vehicle drives out of the lane line includes: determining, according to the position of the vehicle in a world coordinate system and the fitted curve of the lane line, an estimated distance between the vehicle and the lane line, where the running state of the vehicle includes the position of the vehicle in the world coordinate system.

For example, in an application example, if it is assumed that the current position of the vehicle is A, and the position of a point of intersection with a lane line (it is assumed that the lane line is referred to as a target lane line) along the current running direction is B, the segment AB is the trajectory in which the vehicle would drift out of the target lane line in the current state. An absolute position A′ of the vehicle in the world coordinate system is obtained according to the camera calibration parameters, and then the position B of a point of intersection of a straight line A′B and the target lane line along the running direction of the lane line is computed according to a lane line equation of the target lane line, so as to obtain the length of the straight line A′B.

The distance between the vehicle and the target lane line may be obtained according to the setting of the coordinate origin of the lane line equation of the target lane line, the running direction of the vehicle, or the width of the vehicle. For example, if a left wheel of the vehicle is set as the coordinate origin of the lane line equation, the target lane line is on the left side of the vehicle and the distance between the vehicle and a point of intersection of the running direction of the vehicle and the target lane line is directly obtained. If a right wheel of the vehicle is set as the coordinate origin of the lane line equation, the target lane line is on the left side of the vehicle and the sum of the distance between the vehicle and a point of intersection with the target lane line along the running direction of the vehicle and the effective width of the width of the vehicle projected in the running direction of the vehicle is the distance between the vehicle and the target lane line. If the center of the vehicle is set as the coordinate origin of the lane line equation, the target lane line is on the left side of the vehicle and the sum of the distance between the vehicle and a point of intersection with the target lane line along the running direction of the vehicle and the effective width of a half of the width of the vehicle projected in the running direction of the vehicle is the estimated distance between the vehicle and the target lane line.

At S305, in response to the estimated distance being greater than a first preset distance value and less than or equal to a second preset distance value, an estimated time after which the vehicle drives out of the lane line is determined.

On the basis of the foregoing steps, the estimated distance between the vehicle and the lane line is obtained. If the estimated distance is greater than the first preset distance value and less than or equal to the second preset distance value, the estimated time after which the vehicle drives out of the lane line is determined.

According to one or more embodiments of the present disclosure, at step S305, the determining an estimated time after which the vehicle drives out of the lane line includes: determining, according to the speed of the vehicle, the position of the vehicle in the world coordinate system, and the fitted curve of the lane line, an estimated time after which the vehicle drives out of the lane line, where the running state of the vehicle includes the speed of the vehicle and the position of the vehicle in the world coordinate system.

For example, the lateral speed of the vehicle at the current moment is computed by collecting statistics about historical image frame information, a time between the current moment to a moment at which the vehicle drives onto the target lane line (i.e., the time after which the vehicle reaches the target lane line), and the time is determined as the estimated time after which the vehicle drives out of the lane line.

According to one or more embodiments of the present disclosure, the determining, according to the speed of the vehicle, the position of the vehicle in the world coordinate system, and the fitted curve of the lane line, an estimated time after which the vehicle drives out of the lane line includes: obtaining an included angle between the running direction of the vehicle and the fitted curve of the lane line; obtaining, according to the position of the vehicle in the world coordinate system, an estimated distance between the vehicle and the fitted curve of the lane line; and determining, according to the included angle, the estimated distance, and the speed of the vehicle, an estimated time after which the vehicle drives out of the lane line.

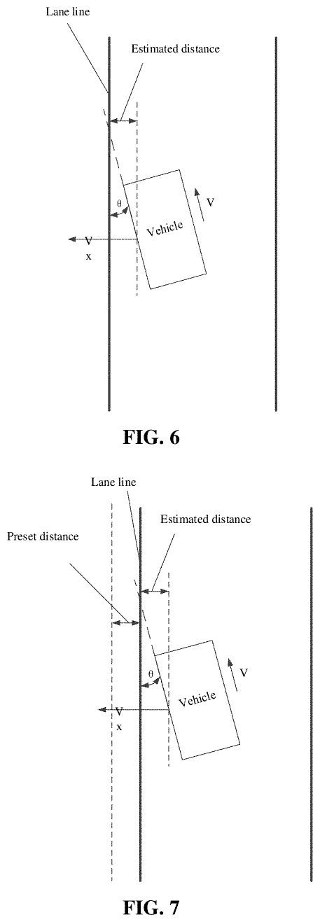

For example, as shown in FIG. 6, an included angle θ between the running direction of the vehicle and the fitted curve of the lane line is obtained. Then, a horizontal component v_x of the running speed of the vehicle is obtained according to the included angle θ and the running speed of the vehicle. An estimated time after which the vehicle drives onto the lane line is obtained according to the estimated distance and the horizontal component v_x of the running speed of the vehicle, for example, t=d/v_x.

According to one or more embodiments of the present disclosure, during an actual running process, it is inevitable that the vehicle may drift onto the lane line for a short time. For example, due to jittering, the head of the vehicle would drift onto the lane line. For such phenomena, after the phenomena disappear, the vehicle would automatically enter the normal driving track. Therefore, no warning is needed in these cases. In order to avoid false warning in the foregoing cases, a critical line of the lane line which is drifted onto is set. For example, as shown in FIG. 7, a critical line (the dotted line on the left side of the lane line in FIG. 7) is set on the side of the lane line away from the vehicle. A warning message is not sent to the vehicle until the vehicle drives onto the critical line, so as to reduce the probability of false warnings. The sum of the estimated distance d and the preset distance c is used as a new estimated distance d′, and the time after which the vehicle drives onto the lane line is determined according to the included angle, the new estimated distance d′ and the running speed of the vehicle.

At S306, intelligent driving control is performed on the vehicle according to the estimated time.

The intelligent driving control method provided by the embodiments of the present disclosure may be executed by any appropriate device having data processing capability, including, but not limited to, a terminal device, a server, or the like. Alternatively, any intelligent driving control method provided in the embodiments of the present disclosure may be executed by a processor, for example, any intelligent driving control method mentioned in the embodiments of the present disclosure is executed by the processor by invoking corresponding instructions stored in a memory. Details are not described below again.

A person of ordinary skill in the art may understand that all or some steps for implementing the foregoing method embodiments may be achieved by a program by instructing related hardware; the foregoing program can be stored in a computer-readable storage medium; when the program is executed, steps including the foregoing method embodiments are executed. Moreover, the foregoing storage medium includes various media capable of storing program codes, such as ROM, RAM, a magnetic disk, or an optical disk.

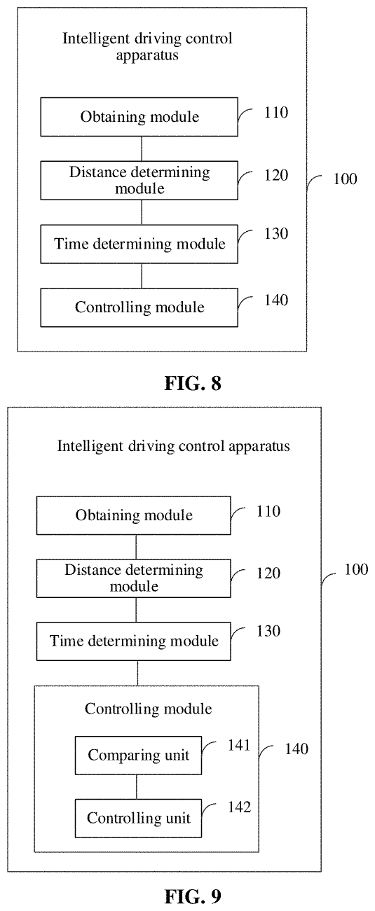

FIG. 8 is a schematic structural diagram of an intelligent driving control apparatus provided by embodiment I of the present disclosure. As shown in FIG. 8, an intelligent driving control apparatus 100 of this embodiment includes: an obtaining module 110 configured to obtain a detection result of a lane line in a running environment of a vehicle; a distance determining module 120 configured to determine, according to a running state of the vehicle and the detection result of the lane line, an estimated distance at which the vehicle drives out of a lane line; a time determining module 130 configured to, in response to the estimated distance being greater than a first preset distance value and less than or equal to a second preset distance value, determine an estimated time after which the vehicle drives out of the lane line; and a controlling module 140 configured to perform intelligent driving control according to the estimated time.

The intelligent driving control apparatus based on a lane line of the embodiments of the present invention is used for executing the technical solutions of the foregoing method embodiments, and the implementation principle and the technical effect thereof are similar. Reference can be made to the corresponding content described above. Details are not described herein again. FIG. 9 is a schematic structural diagram of an intelligent driving control apparatus provided by embodiment II of the present disclosure. On the basis of the foregoing embodiments, as shown in FIG. 9, the control module 140 of this embodiment includes: a comparing unit 141 configured to compare the estimated time with at least one predetermined threshold; and a controlling unit 142 configured to, when the comparison result satisfies one or more preset conditions, performing intelligent driving control corresponding to the satisfied preset condition, where the intelligent driving control includes at least one of the followings: automatic driving control, assisted driving control, or driving mode switching control.

In a possible implementation of this embodiment, the automatic driving control includes any one or more of the followings: performing lane line departure warning, performing braking, changing a running speed, changing a running direction, performing lane line keeping, and changing a vehicle lamp state; and/or the assisted driving control includes at least one of the followings: performing lane line departure early-warning or performing lane line keeping prompting.

The intelligent driving control apparatus based on a lane line of the embodiments of the present invention is used for executing the technical solutions of the foregoing method embodiments, and the implementation principle and the technical effect thereof are similar. Reference can be made to the corresponding content described above. Details are not described herein again.

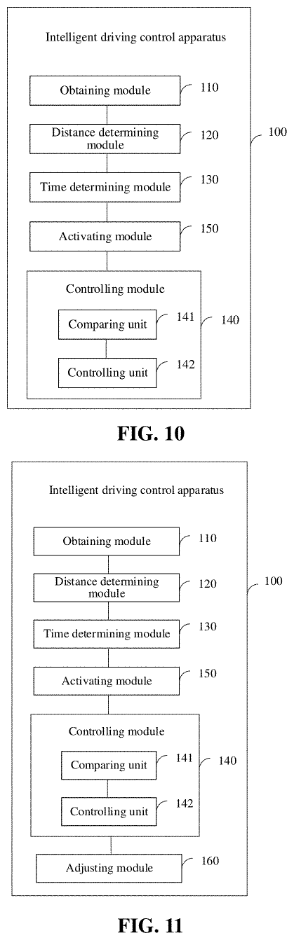

FIG. 10 is a schematic structural diagram of an intelligent driving control apparatus provided by embodiment III of the present disclosure. On the basis of the foregoing embodiments, as shown in FIG. 10, the intelligent driving control apparatus 100 of this embodiment further includes: an activating module 150 configured to, in response to the estimated distance being less than or equal to the second preset distance value or less than the first preset distance value, automatically activate an intelligent driving control function; or in response to the estimated time being less than the predetermined threshold, automatically activate the intelligent driving control function; or in response to detecting that the vehicle drives onto the lane line, automatically activate the intelligent driving control function.

According to one or more embodiments of the present disclosure, when a plurality of preset conditions is included, the degrees of intelligent driving control respectively corresponding to the plurality of preset conditions increase incrementally.

In a possible implementation of this embodiment, the controlling unit 142 is configured to, if the estimated time is less than or equal to a first preset time value and greater than a second preset time value, perform lane line departure early-warning on the vehicle, where the second preset time value is less than the first preset time value.

In a possible implementation of this embodiment, the controlling unit 142 is further configured to, if the estimated time is less than or equal to the second preset time value, performing automatic driving control and/or lane line departure warning on the vehicle, where the lane line departure early-warning includes the lane line departure warning.

In a possible implementation of this embodiment, the controlling unit 142 is further configured to, if a first distance is less than or equal to the first preset distance value, performing automatic driving control and/or lane line departure warning on the vehicle, where the lane line departure early-warning includes the lane line departure warning.

In a possible implementation of this embodiment, the controlling unit 142 is further configured to, if estimated times determined based on an image and a historical image frame are all less than or equal to the second preset time value, perform automatic driving control and/or lane line departure warning on the vehicle, or if estimated distances determined based on the image and the historical image frame are all less than or equal to the first preset distance value, perform automatic driving control and/or lane line departure warning on the vehicle, where the historical image frame includes at least one image frame, in a video where the image is located, having a detection time sequence prior to that of the image.

According to one or more embodiments of the present disclosure, the performing lane line departure warning includes turning on a turn signal light and/or providing a voice prompt.

According to one or more embodiments of the present disclosure, the performing lane line departure early-warning includes at least one of flickering a light, ringing, or providing a voice prompt.

The intelligent driving control apparatus based on a lane line of the embodiments of the present invention is used for executing the technical solutions of the foregoing method embodiments, and the implementation principle and the technical effect thereof are similar. Reference can be made to the corresponding content described above. Details are not described herein again.

FIG. 11 is a schematic structural diagram of an intelligent driving control apparatus provided by embodiment IV of the present disclosure. On the basis of the foregoing embodiments, as shown in FIG. 11, the intelligent driving control apparatus 100 of this embodiment further includes an adjusting module 160, where the obtaining module 110 is further configured to obtain a driving level of a driver of the vehicle; and the adjusting module 160 is configured to adjust, according to the driving level, at least one of the first preset distance value, the second preset distance value, or a preset threshold.

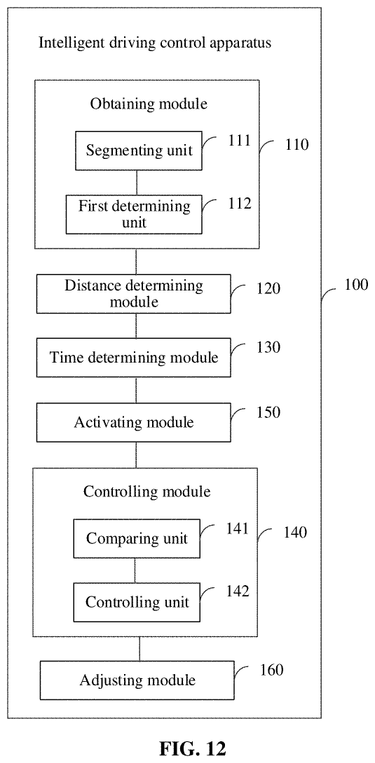

FIG. 12 is a schematic structural diagram of an intelligent driving control apparatus provided by embodiment V of the present disclosure. On the basis of the foregoing embodiments, as shown in FIG. 12, the obtaining module 110 of this embodiment includes: a segmenting unit 111 configured to perform semantic segmentation on an image comprising the running environment of the vehicle by means of a neural network to output a lane line probability map, where the lane line probability map is used for representing a probability value that at least one pixel point in the image separately belongs to a lane line; and a first determining unit 112 configured to determine, according to the lane line probability map, an area where the lane line is located, where the lane line detection result includes the area where the lane line is located.

The intelligent driving control apparatus based on a lane line of the embodiments of the present invention is used for executing the technical solutions of the foregoing method embodiments, and the implementation principle and the technical effect thereof are similar. Reference can be made to the corresponding content described above. Details are not described herein again.

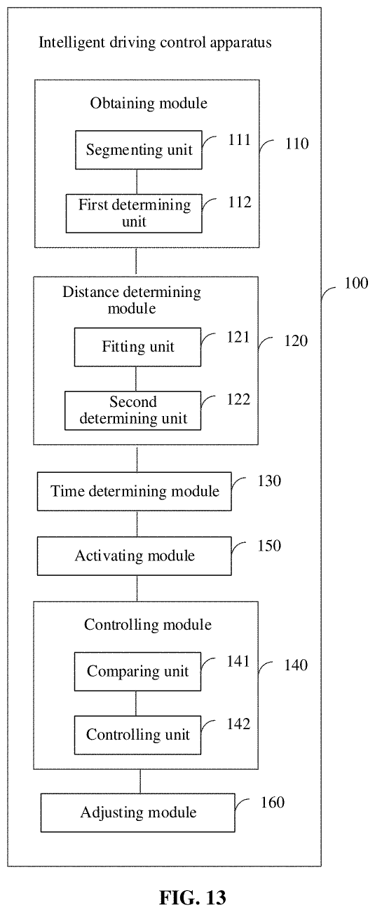

FIG. 13 is a schematic structural diagram of an intelligent driving control apparatus provided by embodiment VI of the present disclosure. On the basis of the foregoing embodiments, as shown in FIG. 13, the distance determining module 120 includes: a fitting unit 121 configured to respectively perform curve fitting on pixel points in the area where each lane line is located to obtain a fitted curve of each lane line; and a second determining unit 122 configured to determine, according to the running state of the vehicle and the fitted curve of the lane line, an estimated distance at which the vehicle drives out of the lane line.

In a possible implementation, the second determining unit 122 is configured to determine, according to the position of the vehicle in a world coordinate system and the fitted curve of the lane line, an estimated distance between the vehicle and the lane line, where the running state of the vehicle includes the position of the vehicle in the world coordinate system.

In a possible implementation, the time determining module 130 is configured to determine, according to the speed of the vehicle, the position of the vehicle in the world coordinate system, and the fitted curve of the lane line, an estimated time after which the vehicle drives out of the lane line, where the running state of the vehicle includes the speed of the vehicle and the position of the vehicle in the world coordinate system.

In a possible implementation, the time determining module 130 is further configured to: obtain an included angle between the running direction of the vehicle and the fitted curve of the lane line; obtain, according to the position of the vehicle in the world coordinate system, an estimated distance between the vehicle and the fitted curve of the lane line; and determine, according to the included angle, the estimated distance, and the speed of the vehicle, an estimated time after which the vehicle drives out of the lane line.

The intelligent driving control apparatus of the embodiments of the present invention is used for executing the technical solutions of the foregoing method embodiments, and the implementation principle and the technical effect thereof are similar. Reference can be made to the corresponding content described above. Details are not described herein again.

The embodiments of the present disclosure further provide an electronic device, including the intelligent driving control apparatus according to any of the foregoing embodiments of the present disclosure.

The embodiments of the present disclosure further provide another electronic device, including: a memory configured to store executable instructions; and a processor configured to communicate with the memory to execute the executable instructions so as to complete steps of the intelligent driving control method according to any one of the foregoing embodiments of the present disclosure.

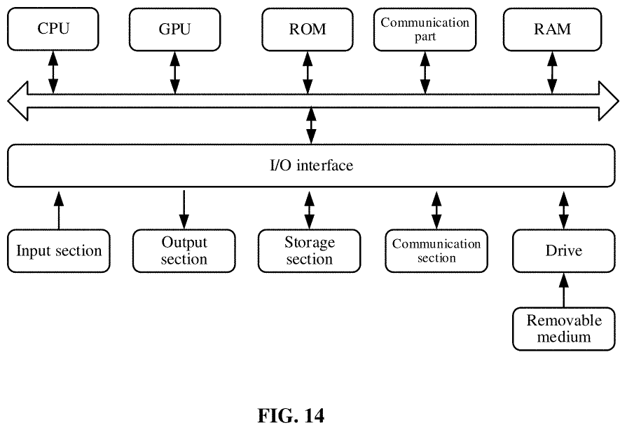

FIG. 14 is a schematic structural diagram of an application embodiment of the electronic device of the present disclosure. Referring to FIG. 14, a schematic structural diagram of the electronic device suitable for implementing a terminal device or a server according to the embodiments of the present disclosure is shown. As shown in FIG. 14, the electronic device includes one or more processors, a communication part, and the like. The one or more processors are, for example, one or more CPUs, and/or one or more GPUs or FPGAs, and the like. The processor may perform various appropriate actions and processing according to executable instructions stored in a Read-Only Memory (ROM) or executable instructions loaded from a storage section to a Random Access Memory (RAM). The communication part may include, but not limited to, a network card. The network card may include, but not limited to, an Infiniband (IB) network card. The processor may communicate with the ROM and/or the RAM, to execute executable instructions. The processor is connected to the communication part via a bus, and communicates with other target devices via the communication part, thereby implementing corresponding operations of any intelligent driving control method provided in the embodiments of the present disclosure, for example, obtaining a lane line detection result of a running environment of a vehicle; determining, according to a running state of the vehicle and the lane line detection result, an estimated distance at which the vehicle drives out of a lane line and/or an estimated time after which the vehicle drives out of the lane line; and performing intelligent driving control on the vehicle according to the estimated distance and/or the estimated time.

In addition, the RAM may further store various programs and data required for operations of an apparatus. The CPU, the ROM, and the RAM are connected to each other via the bus. In the presence of the RAM, the ROM is an optional module. The RAM stores executable instructions, or writes the executable instructions into the ROM during running, where the executable instructions cause the processor to execute corresponding operations of any intelligent driving control method in the embodiments of the present disclosure. An input/output (I/O) interface is also connected to the bus. The communication part may be integrated, or may be configured to have a plurality of sub-modules (for example, a plurality of IB network cards) connected to the bus.

The following components are connected to the I/O interface: an input section including a keyboard, a mouse, and the like; an output section including a Cathode-Ray Tube (CRT), a Liquid Crystal Display (LCD), a speaker, and the like; a storage section including a hard disk drive and the like; and a communication section of a network interface card including an LAN card, a modem, and the like. The communication part performs communication processing via a network such as the Internet. A drive is also connected to the I/O interface according to requirements. A removable medium such as a magnetic disk, an optical disk, a magneto-optical disk, a semiconductor memory or the like is mounted on the drive according to requirements, so that a computer program read from the removable medium is installed on the storage section according to requirements.

It should be noted that the architecture shown in FIG. 14 is merely an optional implementation. During specific practice, the number and types of the components in FIG. 14 may be selected, decreased, increased, or replaced according to actual requirements. Different functional components may be separated or integrated or the like. For example, the GPU and the CPU may be separated, or the GPU may be integrated on the CPU, and the communication part may be separated from or integrated on the CPU or the GPU or the like. These alternative implementations all fall within the scope of protection of the embodiments of the present disclosure.

In addition, the embodiments of the present disclosure further provide a computer storage medium configured to store computer-readable instructions. When the instructions are executed, the operations of the intelligent driving control method according to any one of the foregoing embodiments of the present disclosure are implemented.

In addition, the embodiments of the present disclosure further provide a computer program, including computer-readable instructions. When the computer-readable instructions run in a device, a processor in the device implements the executable instructions for implementing the steps in the intelligent driving control method according to any one of the foregoing embodiments of the present disclosure.

The embodiments in the specification are all described in a progressive manner, for same or similar parts in the embodiments, refer to these embodiments, and each embodiment focuses on a difference from other embodiments. The system embodiments correspond to the method embodiments substantially and therefore are only described briefly, and for the associated part, refer to the descriptions of the method embodiments.

The methods and apparatuses in the embodiments of the present disclosure are implemented in many manners. For example, the methods and apparatuses in the embodiments of the present disclosure are implemented with software, hardware, firmware, or any combination of software, hardware, and firmware. Unless otherwise specially stated, the foregoing sequences of steps of the methods are merely for description, and are not intended to limit the steps of the methods of the embodiments of the present disclosure. In addition, in some embodiments, the present disclosure may be implemented as programs recorded in a recording medium. The programs include machine-readable instructions for implementing the methods according to the embodiments of the present disclosure. Therefore, the embodiments of present disclosure further cover recording media storing the programs for performing the methods according to the embodiments of the present disclosure.

It should be explained at last that: the foregoing embodiments are merely intended for describing the technical solutions of the present disclosure other than limiting the present disclosure. Although the present disclosure is described in detail with reference to the foregoing embodiments, persons of ordinary skill in the art should understand that they may still make modifications to the technical solutions described in the foregoing embodiments or make equivalent replacements to some or all technical features thereof, and such modifications or replacements do not departing the essence of the corresponding technical solutions from the scope of the technical solutions of the embodiments of the present disclosure.

1. An intelligent driving control method, comprising:
obtaining a detection result of a lane line in a running environment of a vehicle;
determining, according to a running state of the vehicle and the detection result of the lane line, an estimated distance by which the vehicle drives out of the lane line;
in response to the estimated distance being greater than a first preset distance value and less than or equal to a second preset distance value, determining an estimated time for which the vehicle drives out of the lane line; and
performing intelligent driving control according to the estimated time.

2. The method according to claim 1, wherein the performing intelligent driving control according to the estimated time comprises:
comparing the estimated time with at least one predetermined threshold; and
when the comparison result satisfies one or more preset conditions, performing intelligent driving control corresponding to the satisfied preset condition, wherein the intelligent driving control comprises at least one of the followings: automatic driving control, assisted driving control, or driving mode switching control.

3. The method according to claim 2, wherein
the automatic driving control comprises any one or more of the followings: performing lane line departure warning, performing braking, changing a running speed, changing a running direction, performing lane line keeping, or changing a state of vehicle lamp; and
the assisted driving control comprises at least one of the followings: performing lane line departure early-warning or performing lane line keeping prompting.

4. The method according to claim 1, further comprising:
in response to the estimated distance being less than or equal to the second preset distance value or less than the first preset distance value, automatically activating an intelligent driving control function; or
in response to the estimated time being less than the predetermined threshold, automatically activating the intelligent driving control function; or
in response to detecting that the vehicle drives onto the lane line, automatically activating the intelligent driving control function.

5. The method according to claim 2, wherein when the one or more preset conditions comprises a plurality of preset conditions, degrees of intelligent driving control respectively corresponding to the plurality of preset conditions increase incrementally.

6. The method according to claim 5, wherein the when the comparison result satisfies one or more preset conditions, performing intelligent driving control corresponding to the satisfied preset condition comprises:
if the estimated time is less than or equal to a first preset time value and greater than a second preset time value, performing the lane line departure early-warning on the vehicle, wherein the second preset time value is less than the first preset time value.

7. The method according to claim 5, wherein the when the comparison result satisfies one or more preset conditions, performing intelligent driving control corresponding to the satisfied preset condition further comprises:
if the estimated time is less than or equal to the second preset time value, performing the automatic driving control and/or the lane line departure warning on the vehicle, wherein the lane line departure early-warning comprises the lane line departure warning.

8. The method according to claim 5, further comprising: if a first distance is less than or equal to the first preset distance value, performing the automatic driving control and/or the lane line departure warning on the vehicle, wherein the lane line departure early-warning comprises the lane line departure warning.

9. The method according to claim 8, wherein the if the estimated time is less than or equal to the second preset time value, performing the automatic driving control and/or the lane line departure warning on the vehicle comprises: if both an estimated time determined based on an image and an estimated time determined based on a historical frame image are less than or equal to the second preset time value, performing the automatic driving control and/or the lane line departure warning on the vehicle; or
the if a first distance is less than or equal to the first preset distance value, performing the automatic driving control and/or the lane line departure warning on the vehicle comprises: if both an estimated distance determined based on the image and an estimated distance determined based on the historical frame image are less than or equal to the first preset distance value, performing the automatic driving control and/or the lane line departure warning on the vehicle,
wherein the historical frame image comprises at least one frame of image in a video where the image is located, of which a detection time sequence is prior to that of the image.

10. The method according to claim 3, wherein the performing lane line departure warning comprises turning on a turn signal light and/or providing a voice prompt.

11. The method according to claim 4, wherein the performing lane line departure early-warning comprises at least one of flickering a light, ringing, or providing a voice prompt.

12. The method according to claim 2, further comprising:
obtaining a driving level of a driver of the vehicle; and
adjusting, according to the driving level, at least one of the first preset distance value, the second preset distance value, or a preset threshold.

13. The method according to claim 1, wherein the obtaining a detection result of a lane line in a running environment of a vehicle comprises:
performing semantic segmentation on an image comprising the running environment of the vehicle through a neural network to output a lane line probability map, wherein the lane line probability map is used for representing a probability that each of at least one pixel point in the image belongs to a lane line; and
determining, according to the lane line probability map, an area where the lane line is located, wherein the detection result of the lane line comprises the area where the lane line is located.

14. The method according to claim 13, wherein the determining, according to a running state of the vehicle and the detection result of the lane line, an estimated distance by which the vehicle drives out of a lane line comprises:
respectively performing curve fitting on pixel points in the area where each lane line is located to obtain a fitted curve of each lane line; and
determining, according to the running state of the vehicle and the fitted curve of the lane line, the estimated distance by which the vehicle drives out of the lane line.

15. The method according to claim 14, wherein the determining, according to the running state of the vehicle and the fitted curve of the lane line, the estimated distance by which the vehicle drives out of the lane line comprises:
determining, according to a position of the vehicle in a world coordinate system and the fitted curve of the lane line, an estimated distance between the vehicle and the lane line, wherein the running state of the vehicle comprises the position of the vehicle in the world coordinate system.

16. The method according to claim 14, wherein the determining an estimated time for which the vehicle drives out of the lane line comprises:
determining the estimated time by which the vehicle drives out of the lane line according to a speed of the vehicle, the position of the vehicle in the world coordinate system and the fitted curve of the lane line, wherein the running state of the vehicle comprises the speed of the vehicle and the position of the vehicle in the world coordinate system.

17. The method according to claim 16, wherein the determining, according to the speed of the vehicle, the position of the vehicle in the world coordinate system, and the fitted curve of the lane line, an estimated time for which the vehicle drives out of the lane line comprises:
obtaining an included angle between a running direction of the vehicle and the fitted curve of the lane line;
obtaining, according to the position of the vehicle in the world coordinate system, an estimated distance between the vehicle and the fitted curve of the lane line; and
determining, according to the included angle, the estimated distance, and the speed of the vehicle, the estimated time for which the vehicle drives out of the lane line.

18. An electronic device, comprising:
a processor; and
a memory configured to store instructions executable by the processor;
wherein the processor is configured to:
obtain a detection result of a lane line in a running environment of a vehicle;
determine, according to a running state of the vehicle and the detection result of the lane line, an estimated distance by which the vehicle drives out of the lane line;
in response to the estimated distance being greater than a first preset distance value and less than or equal to a second preset distance value, determine an estimated time for which the vehicle drives out of the lane line; and
perform intelligent driving control according to the estimated time.

19. The electronic device according to claim 18, wherein the processor is configured to:
compare the estimated time with at least one predetermined threshold; and
when the comparison result satisfies one or more preset conditions, performing intelligent driving control corresponding to the satisfied preset condition, wherein the intelligent driving control comprises at least one of the followings: automatic driving control, assisted driving control, or driving mode switching control.

20. A non-transitory computer storage medium having stored therein computer programs, wherein the computer program, when being executed, causes to implement the intelligent driving control method, the method comprising:
obtaining a detection result of a lane line in a running environment of a vehicle;
determining, according to a running state of the vehicle and the detection result of the lane line, an estimated distance by which the vehicle drives out of the lane line;
in response to the estimated distance being greater than a first preset distance value and less than or equal to a second preset distance value, determining an estimated time for which the vehicle drives out of the lane line; and
performing intelligent driving control according to the estimated time.
